(19) United States
(12) Patent Application Publication
(10) Pub. No.: US 2017/0090516 A1
(43) Pub. Date: Mar. 30, 2017

(54) DOCKING STATION

(71) Applicant: Intel Corporation, Santa Clara, CA (US)

(72) Inventors: Jeff Ku, Taipei (TW); Pei-yang Sung, Taichung City (TW); Ming-Che Lee, New Taipei City (TW); Oliver Tsui, Taipei (TW); Simon Tsai, Tao (TW)

(73) Assignee: Intel Corporation, Santa Clara, CA (US)

(21) Appl. No.: 14/866,742

(22) Filed: Sep. 25, 2015

(51) Int. Cl. G06F 1/16; H02J 7/00

(52) U.S. Cl. CPC G06F 1/1632; H02J 7/0042; G06F 1/1696; G06F 1/1635; G06F 1/1681

(57) ABSTRACT

Particular embodiments described herein provide for an electronic device, that includes a main body, an interconnect attached to the main body, where the interconnect can electrically couple with different sized first housings, a hinge attached to the interconnect, where the hinge can rotatably couple the interconnect with the main body, and a porch, where the porch can accommodate different sized second housings.

### TECHNICAL FIELD

This disclosure relates in general to the field of electronic devices, and more particularly, to a docking station for an electronic device.

### BRIEF DESCRIPTION OF THE DRAWINGS

To provide a more complete understanding of the present disclosure and features and advantages thereof, reference is made to the following description, taken in conjunction with the accompanying FIGURES, embodiments are illustrated by way of example and not by way of limitation in the FIGURES of the accompanying drawings, in which like references indicate similar elements and in which:

FIG. 1A is a simplified schematic diagram illustrating an orthographic view of an embodiment of a docking station, in accordance with one embodiment of the present disclosure;

FIG. 1B is a simplified schematic diagram illustrating an orthographic view of an embodiment of a docking station, in accordance with one embodiment of the present disclosure;

FIG. 1C is a simplified schematic diagram illustrating an orthographic view of an embodiment of an electronic device with a docking station, in accordance with one embodiment of the present disclosure;

FIG. 2 is a simplified schematic diagram illustrating an orthographic view of an embodiment of a docking station, in accordance with one embodiment of the present disclosure;

FIG. 3 is a simplified schematic diagram illustrating an orthographic view of an embodiment of a docking station, in accordance with one embodiment of the present disclosure;

FIG. 4 is a simplified schematic diagram illustrating an orthographic view of an embodiment of a docking station, in accordance with one embodiment of the present disclosure;

FIG. 5 is a simplified schematic diagram illustrating an orthographic view of an embodiment of a docking station, in accordance with one embodiment of the present disclosure;

FIG. 6 is a simplified schematic diagram illustrating an orthographic view of an embodiment of a docking station, in accordance with one embodiment of the present disclosure;

FIG. 7 is a simplified schematic diagram illustrating an orthographic view of an embodiment of a docking station, in accordance with one embodiment of the present disclosure;

FIG. 8 is a simplified schematic diagram illustrating an orthographic view of an embodiment of a docking station, in accordance with one embodiment of the present disclosure;

FIG. 9 is a simplified schematic diagram illustrating a plan view of an embodiment of a docking station, in accordance with one embodiment of the present disclosure

FIG. 10 is a simplified schematic diagram illustrating an orthographic view of an embodiment of a docking station, in accordance with one embodiment of the present disclosure;

FIG. 11 is a simplified schematic diagram illustrating an orthographic view of an embodiment of a docking station, in accordance with one embodiment of the present disclosure;

FIG. 12 is a simplified schematic diagram illustrating an orthographic view of an embodiment of a docking station, in accordance with one embodiment of the present disclosure;

FIG. 13 is a simplified schematic diagram illustrating an orthographic view of an embodiment of a docking station, in accordance with one embodiment of the present disclosure;

FIG. 14 is a simplified schematic diagram illustrating an orthographic view of an embodiment of a docking station, in accordance with one embodiment of the present disclosure;

FIG. 15 is a simplified schematic diagram illustrating block diagram views of various embodiments of a docking station, in accordance with one embodiment of the present disclosure;

FIG. 16 is a simplified schematic diagram illustrating an exploded orthographic view of an embodiment of a docking station, in accordance with one embodiment of the present disclosure; and

FIG. 17 is a simplified schematic diagram illustrating an orthographic view of an embodiment of a docking station, in accordance with one embodiment of the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

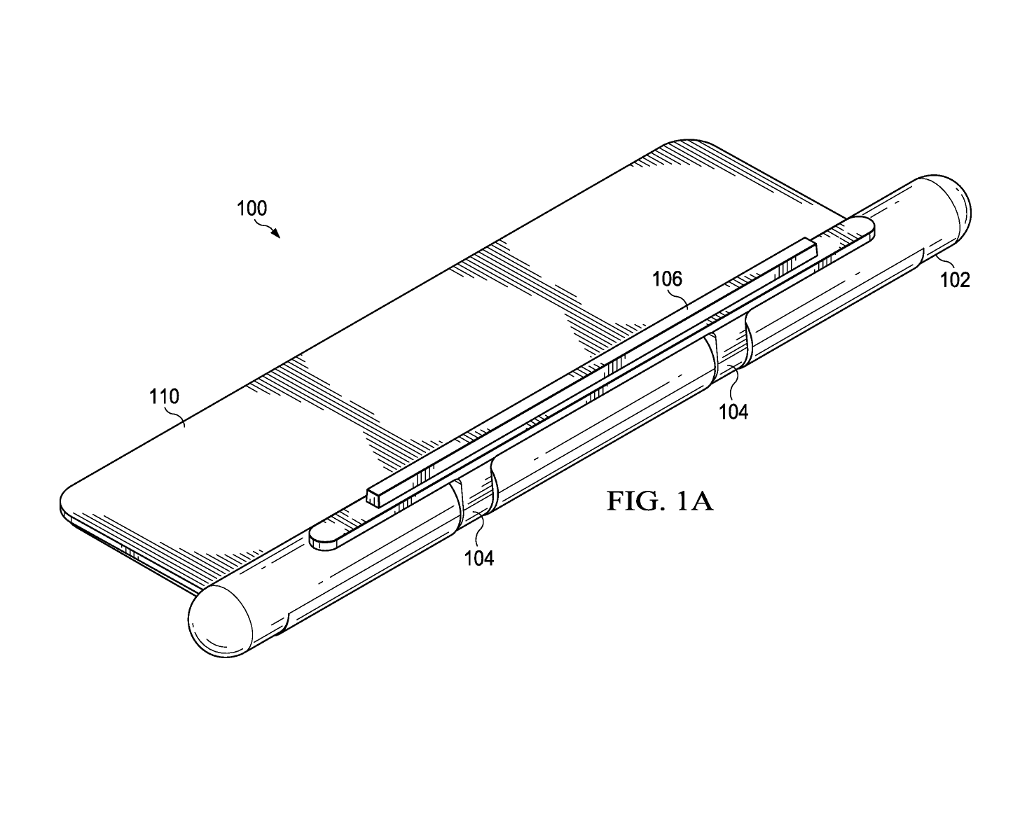

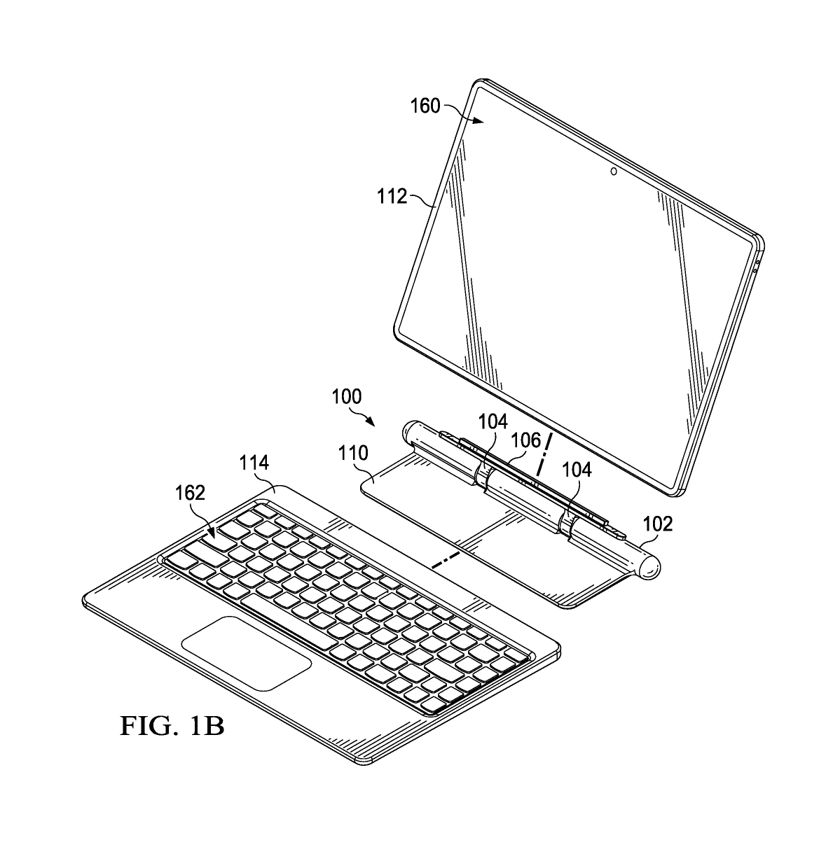

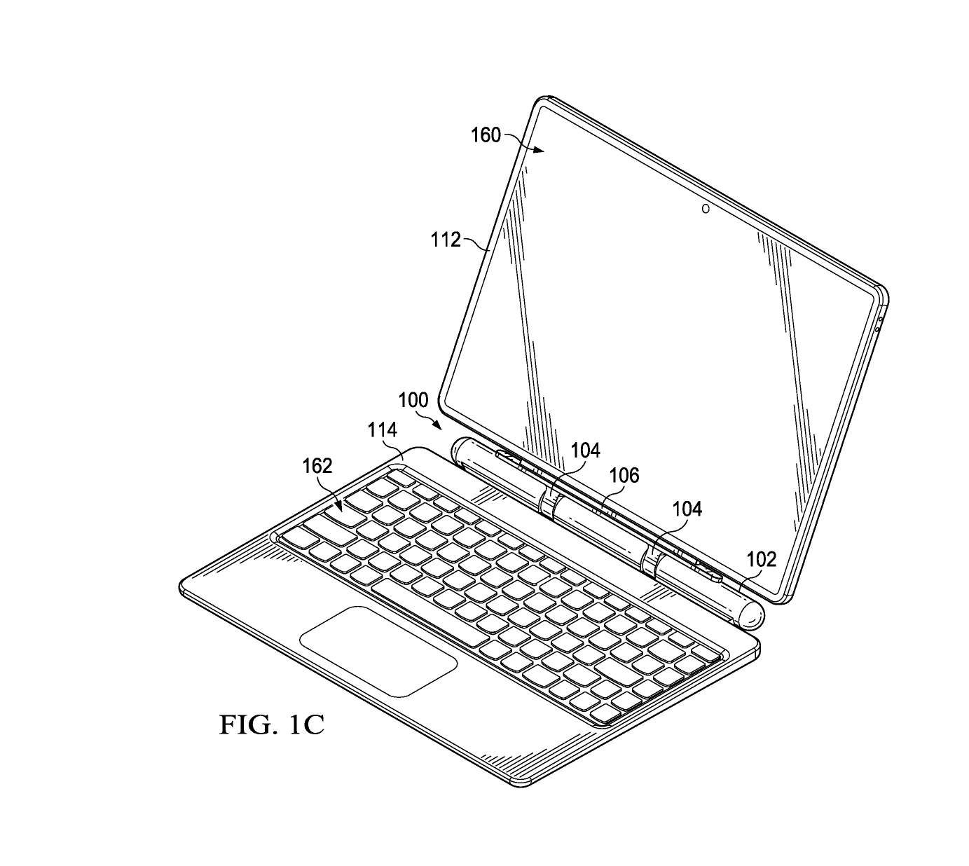

FIG. 1A is a simplified orthographic view illustrating an embodiment of a docking station 100 in accordance with one embodiment of the present disclosure. Docking station 100 can include a main body 102, one or more hinges 104, a docking interconnect 106, and a porch 110. One or more hinges 104 can define an axis of rotation that is shared between main body 102 and docking interconnect 106. Main body 102 can include electronic components and a battery or power supply.

Turning to FIG. 1B, FIG. 1B is a simplified orthographic view illustrating an embodiment of docking station 100 in accordance with one embodiment of the present disclosure. As illustrated in FIG. 1B, a first housing 112 and a second housing 114 can be docked with docking station 100. Docking interconnect 106 can be configured to couple to first housing 112. First housing 112 can be a variety of sizes and profiles and include a display 120. Second housing 114 can be a variety of sizes and profiles and the sizing and profile of second housing 114 does not need to correlate to the sizing and profile of first housing 112. Second housing 114 can include a keyboard 162. Keyboard 162 may be a virtual keyboard or a physical keyboard.

Turning to FIG. 1C, FIG. 1C is a simplified orthographic view illustrating an embodiment of docking station 100 in accordance with one embodiment of the present disclosure. As illustrated in FIG. 1C, first housing 112 has been docked with docking station 100. Docking interconnect 106 can allow first housing 112 to couple with docking station 100 and be configured to allow for electrical communication and power to flow between docking station 100 and first housing 112. Second housing 114 can rest or be positioned on porch 110 and help prevent tipping when docking station 100 is coupled to first housing 112. When docked, hinges 104 can be rotated to provide a desired viewing angle of first housing 112.

In an example, docking station 100 can include various components of an internal electronic system of an electronic device. The components may include a battery, central processing unit (CPU), a memory, etc. Any processors (inclusive of digital signal processors, microprocessors, supporting chipsets, etc.), memory elements, etc. can be suitably coupled to a motherboard based on particular configuration needs, processing demands, computer designs, etc.

Note that particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and often radio frequency functions: all of which may be provided on a single chip substrate.

For purposes of illustrating certain example features of docking station 100, the following foundational information may be viewed as a basis from which the present disclosure may be properly explained.

Current detachable 2in1 designs requires a keyboard base with exactly the same size specifically for the tablet, which may either increase the design and build cost for the device or lack of expandability for end users. Often a tablet with a kickstand is generally thinner and lighter than a 2in1 device, however the usability of the tablet alone can be limited without hinges as the kickstand cannot replace the hinge completely due to its limited range. What is needed is a hinged kickstand that can accommodate a variety of different bases. It would be beneficial if the hinged kickstand could also include selectable components to increase expandability of a 2in1 design.

A docking station, as outlined in FIGS. 1A-1C, can resolve these issues (and others). Docking station 100 can be configured to accommodate a variety of different housings and bases depending on a user's preference. In addition, docking station 100 can be configured to include a variety of components (e.g., inside main body 102) depending on a desired use or function.

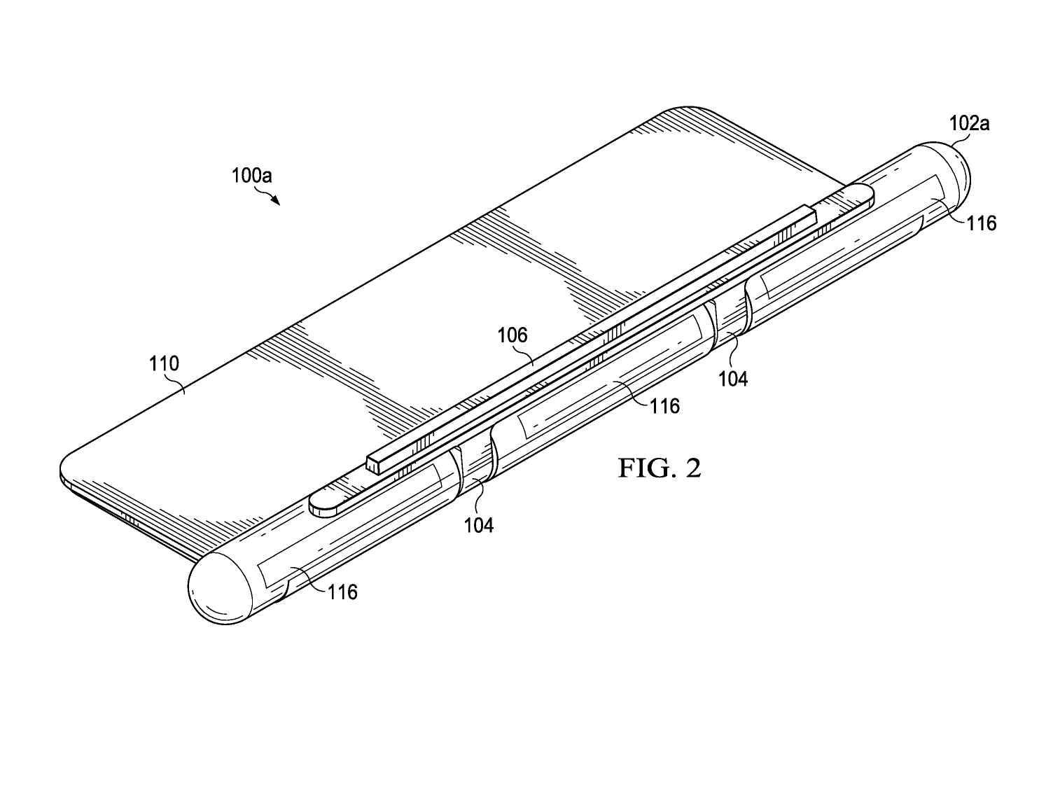

Turning to FIG. 2, FIG. 2 is a simplified orthographic view illustrating an embodiment of docking station 100a in accordance with one embodiment of the present disclosure. Docking station 100a can include a charging body 102a, one or more hinges 104, docking interconnect 106, and porch 110. Charging body 102a can include one or more charging elements 116. Charging elements 116 may be one or more batteries, charging cells, or other elements able to hold a charge and charge another device such as first housing 112 and/or second housing 114. For example, when first housing 112 is coupled to docking interconnect 106, charging elements 116 may be able to charge an onboard battery in first housing 112.

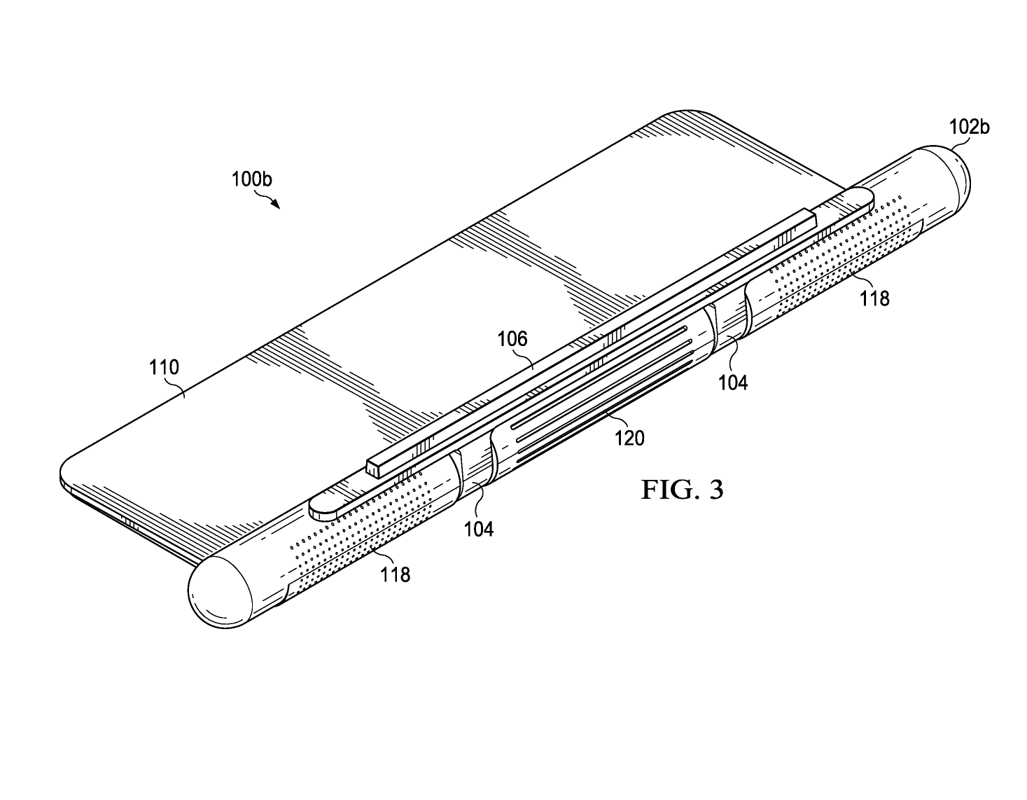

Turning to FIG. 3, FIG. 3 is a simplified orthographic view illustrating an embodiment of docking station 100b in accordance with one embodiment of the present disclosure. Docking station 100b can include an audio body 102b, one or more hinges 104, docking interconnect 106, and porch 110. Audio body 102b can include one or more speakers 118 and a fan 120. Speakers 118 can be configured to play audio sounds from a connected device. For example, when first housing 112 is connected to audio body 102b, speakers 118 can play the audio of a song or video being played on first housing 112. Fan 120 can be configured to cool or otherwise move air around audio dock 102b.

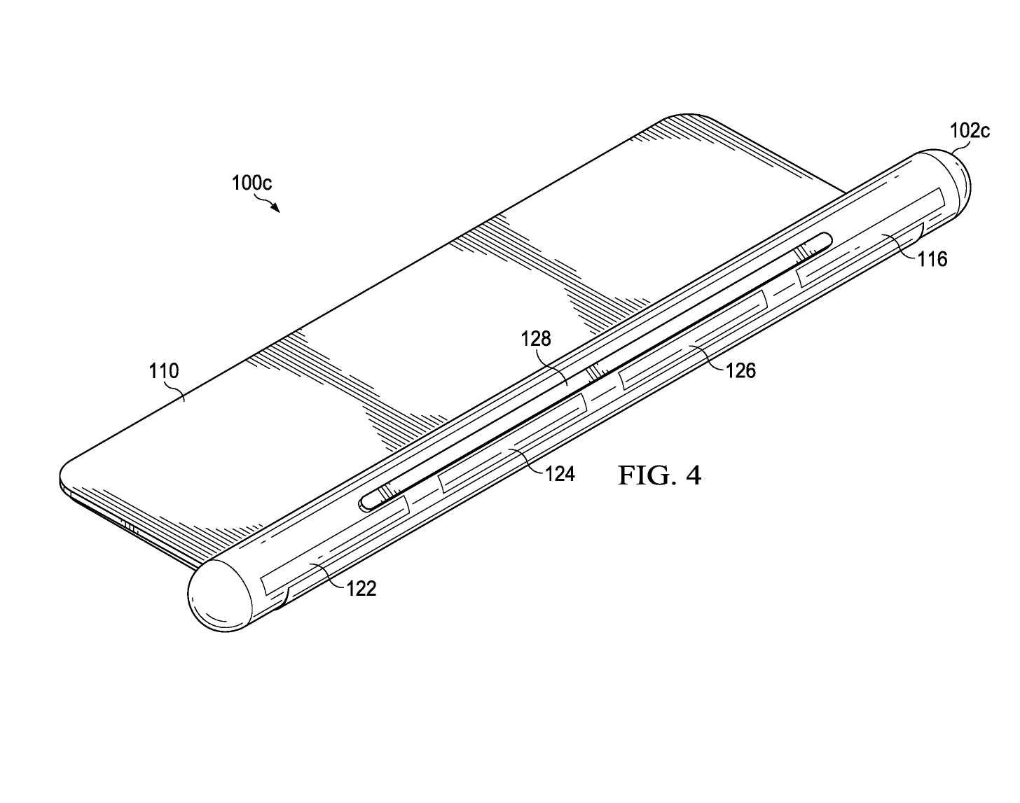

Turning to FIG. 4, FIG. 4 is a simplified orthographic view illustrating an embodiment of docking station 100c in accordance with one embodiment of the present disclosure. Docking station 100c can include electronic element body 102c, porch 110, and fixed interconnect 128. Electronic element body 102c can include one or more charging elements 116, a first electronic element 122, a second electronic element 124, and a third electronic element 126. In other examples, electronic element body 102c can include one or more electronic elements and each electronic element may the same, each electronic element may be different, or some electronic elements may be the same and some may be different.

In an example, first electronic element 122 may be memory such that when first housing 112 is coupled to fixed interconnect 128, the memory of first housing 112 is increased by the memory capacity of first electronic element 122. In another example, second electronic element 124 may be a graphics process such that when first housing 112 is coupled to fixed interconnect 128, the graphics processing capabilities of first housing 112 is increased by the graphics processing capabilities of second electronic element 124. In yet another example, third electronic element may be a wireless module such that when first housing 112 is coupled to fixed interconnect 128, first housing has the wireless capability of the wireless module (e.g., WiFI, Bluetooth®, GPS, etc.)

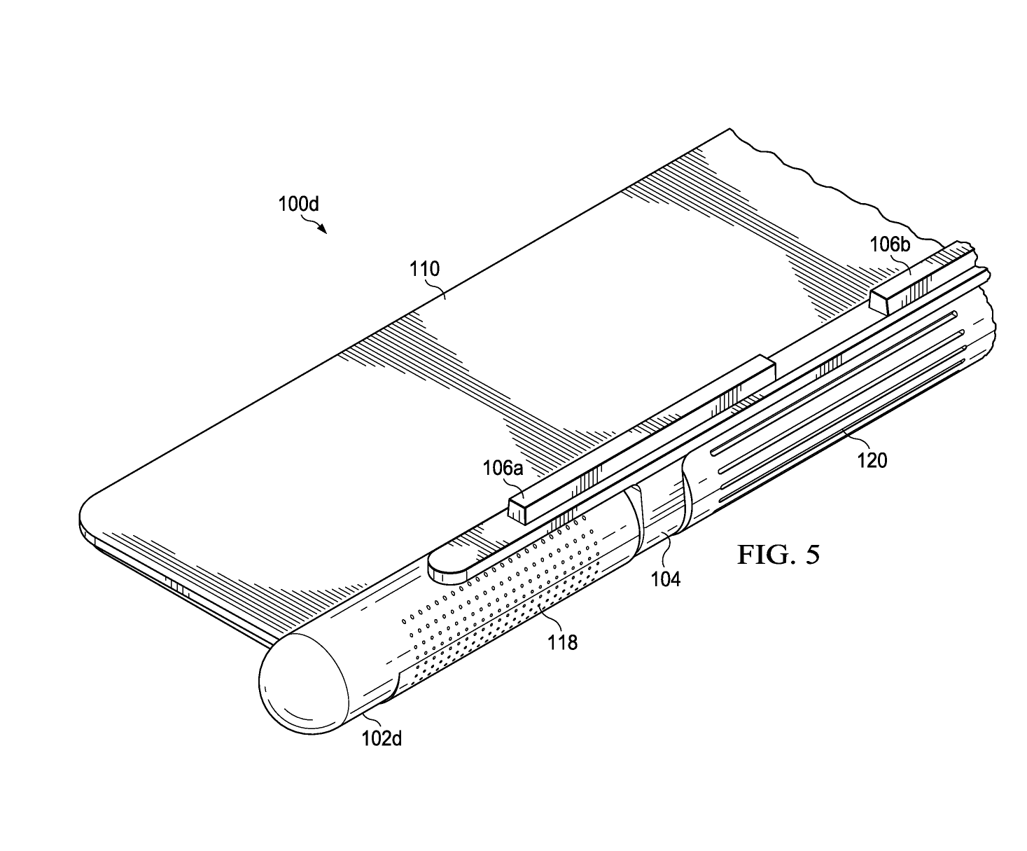

Turning to FIG. 5, FIG. 5 is a simplified orthographic view illustrating an embodiment of docking station 100d in accordance with one embodiment of the present disclosure. Docking station 100d can include body 102d, a hinge 104, two or more interconnects 106a and 106b, and porch 110. Body 102d can include speakers 118 and fan 120.

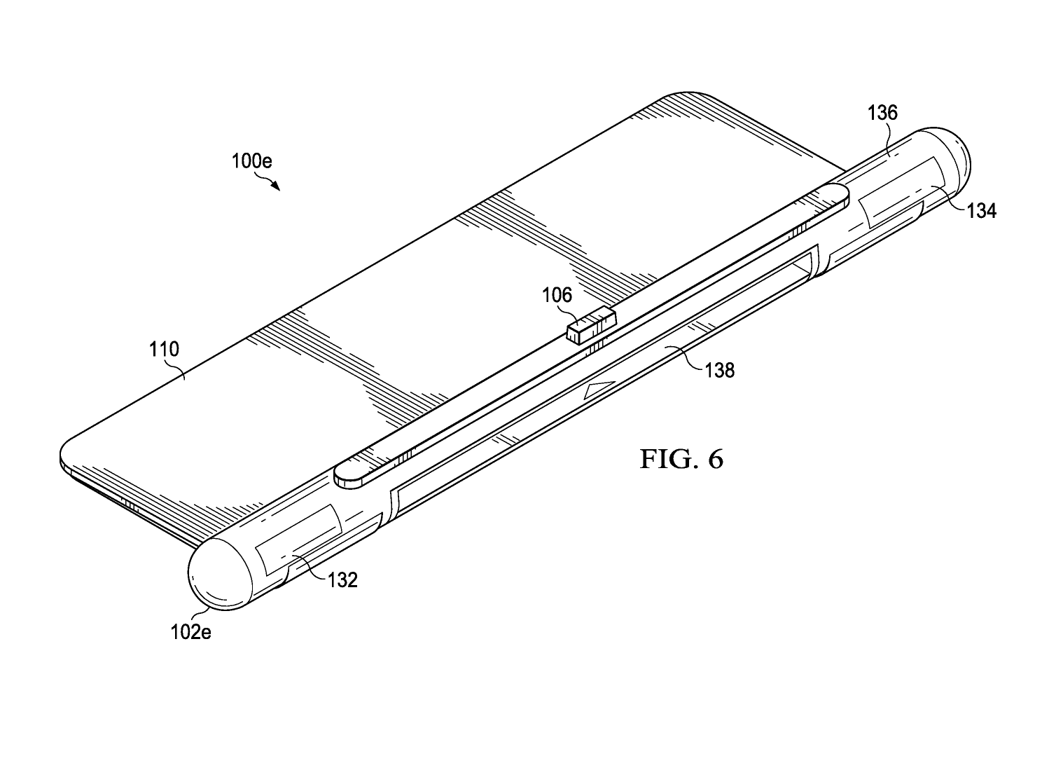

Turning to FIG. 6, FIG. 6 is a simplified orthographic view illustrating an embodiment of docking station 100e in accordance with one embodiment of the present disclosure. Docking station 100e can include body 102e, docking interconnect 106, and porch 110. Body 102e can include a scanning module 132, a printing module 134, and a paper port 138.

Scanning module 132 can be configured to scan paper or other material feed through paper port 138. For example, when first housing 114 is coupled to docking station 100e using docking interconnect 106, a document can be feed into paper port 138 and scanned using scanning module 132 to create a digital copy of the document. The digital copy of the document can be communicated to first housing 114 for storage, display on a screen, emailed or text, etc.

Printing module 134 can be configured to print on paper or other material fed through paper port 138. For example, when first housing 114 is coupled to docking station 100e using docking interconnect 106, a document or image on a display of first housing 114 can be sent to printing module 134. Printing module can cause a physical representation of the document or image on display 160 to be copied or printed on paper or other material fed through paper port 138.

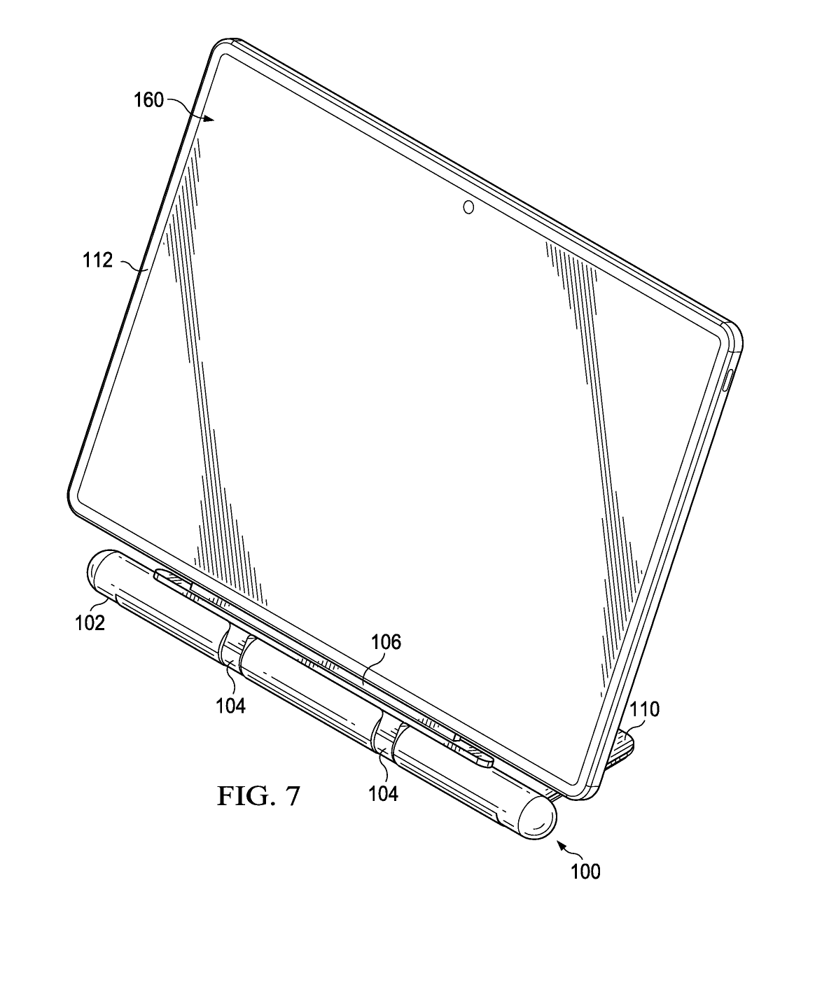

Turning to FIG. 7, FIG. 7 is a simplified orthographic view illustrating an embodiment of docking station 100 in accordance with one embodiment of the present disclosure. As illustrated in FIG. 7, first housing 112 has been coupled to docking station 100. Using one or more hinges 104, a viewing angle of display 160 can be adjusted. Porch 110 can provide support for docking station 100 and first housing 112 such that they do not tip over.

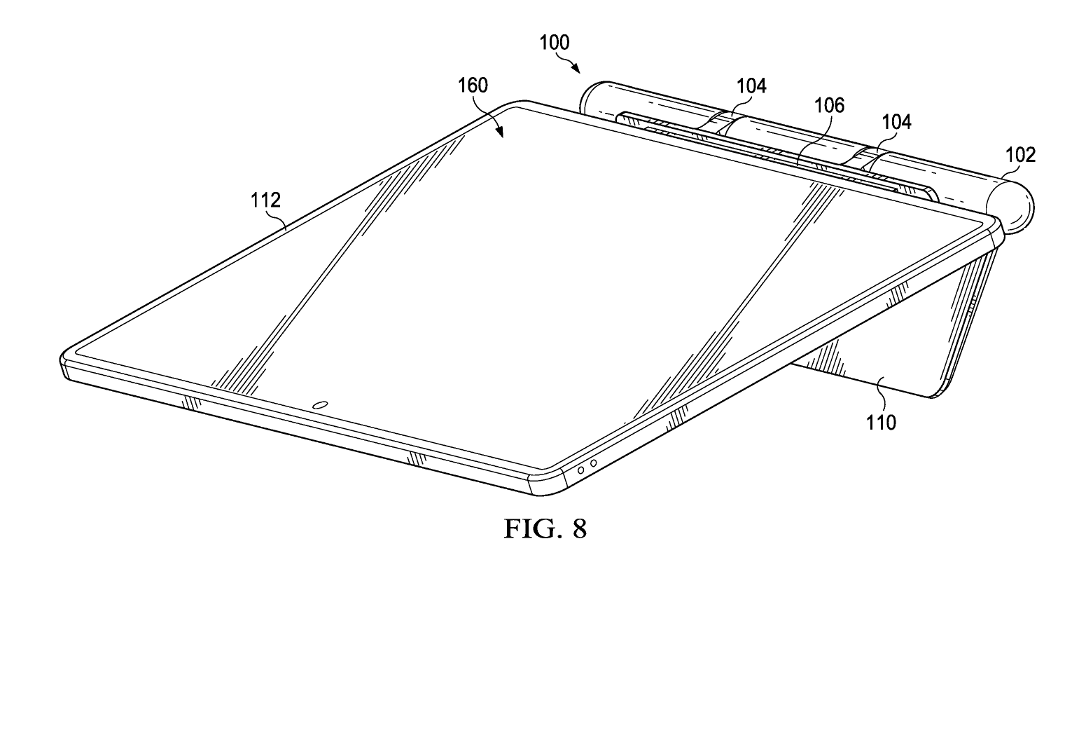

Turning to FIG. 8, FIG. 8 is a simplified orthographic view illustrating an embodiment of docking station 100 in accordance with one embodiment of the present disclosure. As illustrated in FIG. 8, first housing 112 has been coupled to docking station 100. Porch 110 can provide support for docking station 100 and first housing 112 such that display 160 can be viewed from a raised angle rather than flat on a surface.

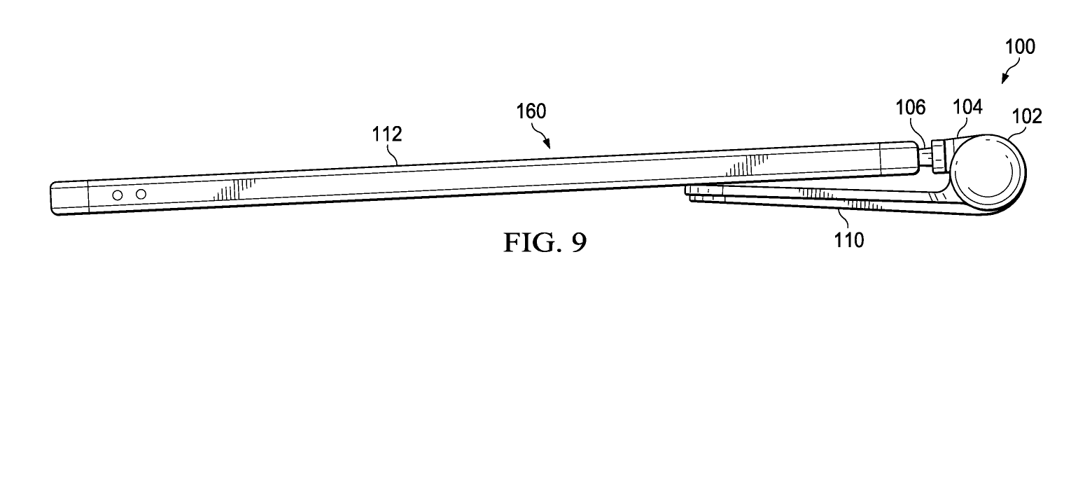

Turning to FIG. 9, FIG. 9 is a simplified orthographic view illustrating an embodiment of docking station 100 in accordance with one embodiment of the present disclosure. As illustrated in FIG. 9, first housing 112 has been coupled to docking station 100. Using one or more hinges 104, porch 110 can be rotated to a side opposite of display 160 in a stowed configuration.

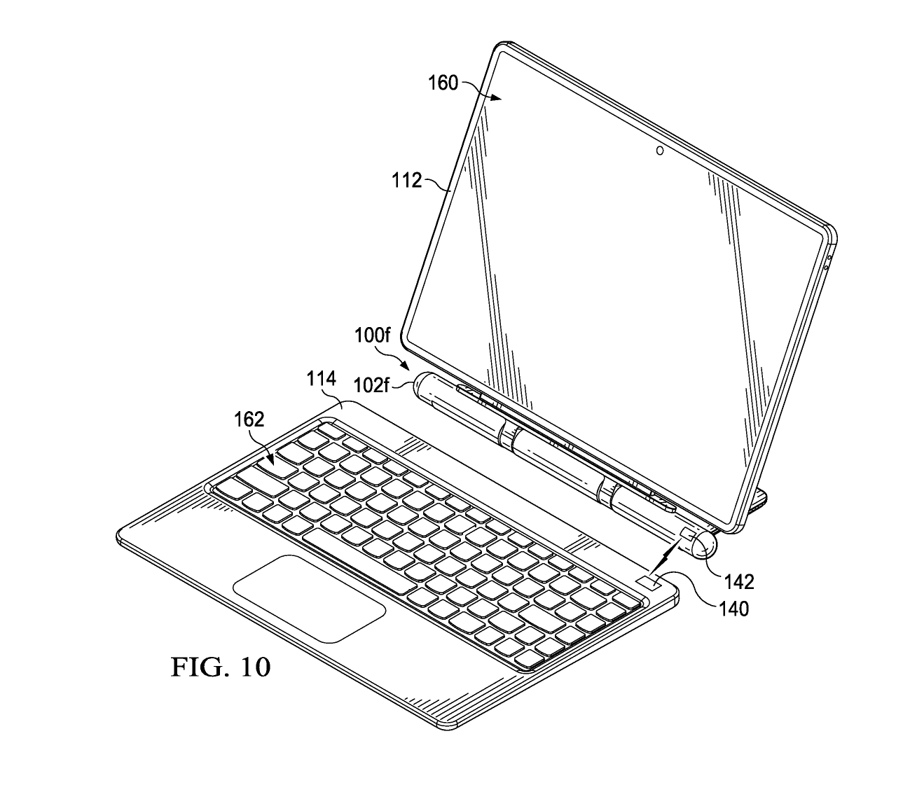

Turning to FIG. 10, FIG. 10 is a simplified orthographic view illustrating an embodiment of docking station 100f in accordance with one embodiment of the present disclosure. Docking station 100f can include body 102f and body 102f can include a docking station wireless module 142. Secondary housing 114 can include keyboard 162 and a second housing wireless module 140. Docking station wireless module 142 and second housing wireless module 140 can communicate wirelessly (e.g., Bluetooth®, etc.). For example, input from keyboard 162 can be communicated to second housing wireless module 140. Second housing wireless module 140 can communicate the input to docking station wireless module 142 and on to first housing 112 using an interconnect (e.g., docking interconnect 106).

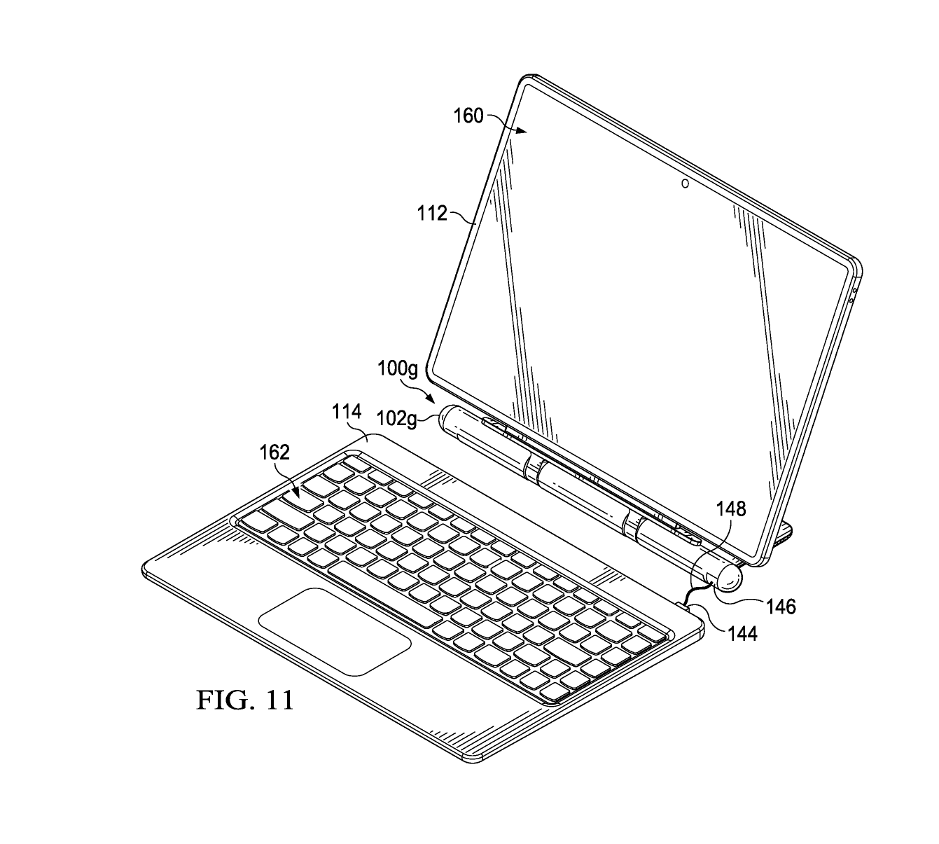

Turning to FIG. 11, FIG. 11 is a simplified orthographic view illustrating an embodiment of docking station 100g in accordance with one embodiment of the present disclosure. Docking station 100g can include body 102g and body 102g can include a docking station communication module 146. Secondary housing 114 can include keyboard 162 and a second housing communication module 144. Docking station communication module 146 and second housing communication module 144 can communicate using wired connection 148 (e.g., USB, etc). For example, input from keyboard 162 can be communicated to second housing communication module 144. Using wired connection 148, second housing communication module 144 can communicate the input to docking station communication module 146 and on to first housing 112 using an interconnect (e.g., docking interconnect 106).

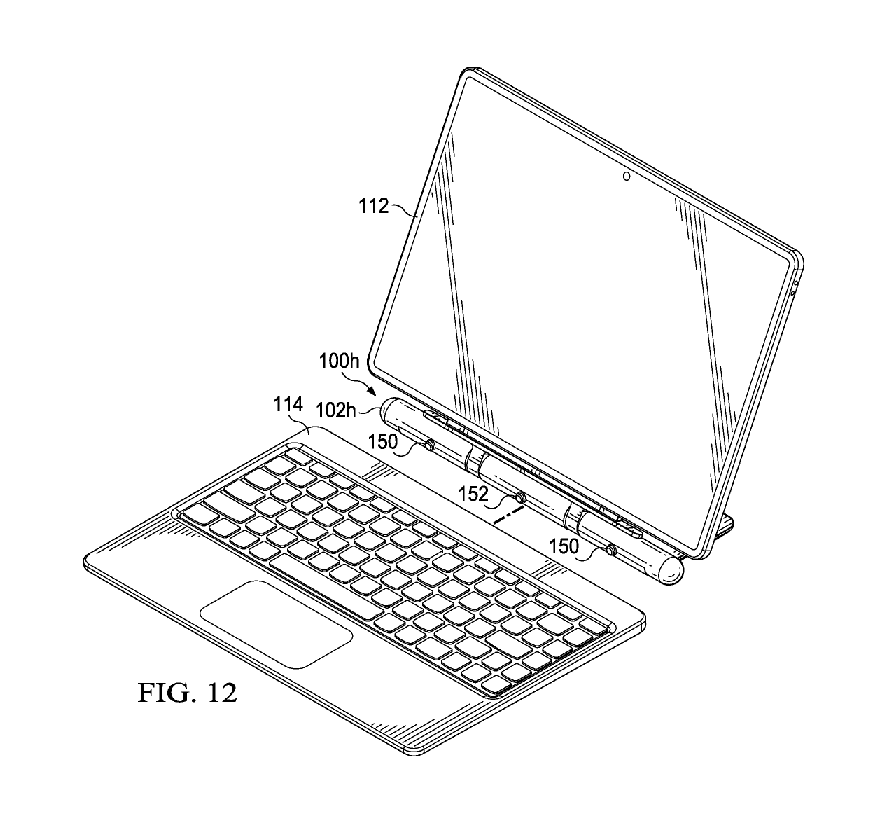

Turning to FIG. 12, FIG. 12 is a simplified orthographic view illustrating an embodiment of docking station 100h in accordance with one embodiment of the present disclosure. Docking station 100h can include body 102h. Body 102h can include a secondary housing attachment means 150 and secondary housing interconnect 152. In an example, secondary housing attachment means 150 can be configured to couple secondary housing 114 to docking station 100h. Secondary housing interconnect 152 can be configured to couple secondary housing 114 to docking station 100h and allow for communications and power transfer between secondary housing 114 and docking station 100h.

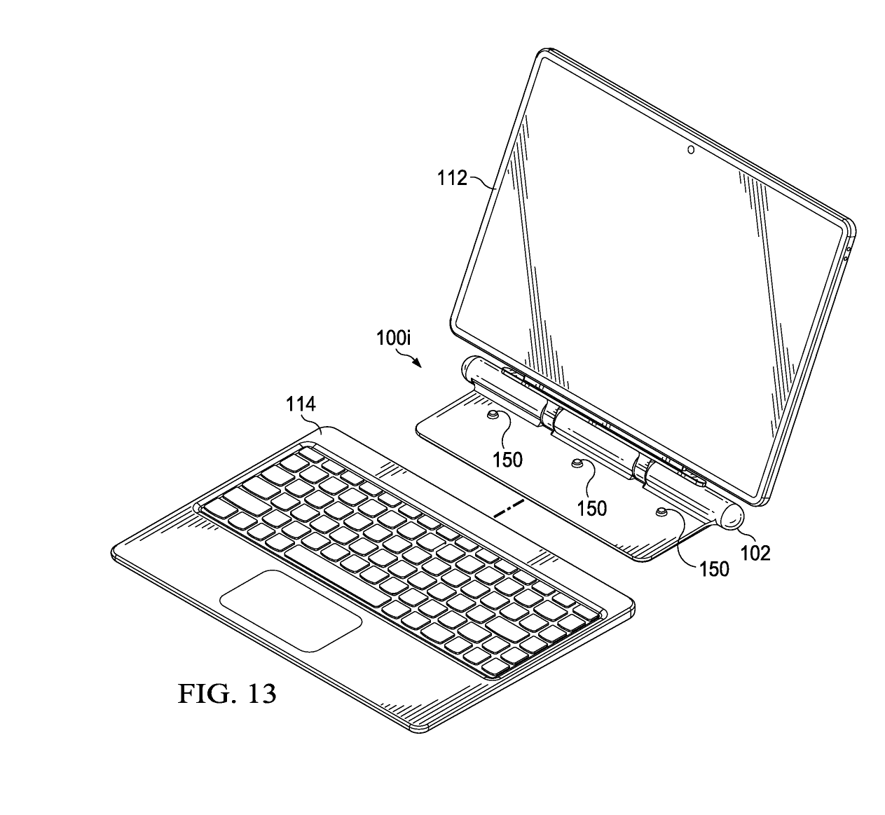

Turning to FIG. 13, FIG. 13 is a simplified orthographic view illustrating an embodiment of docking station 100i in accordance with one embodiment of the present disclosure. Docking station 100i can include body 102 and one or more secondary housing attachment means 150. In an example, secondary housing attachment means 150 can be configured to couple secondary housing 114 to docking station 100j.

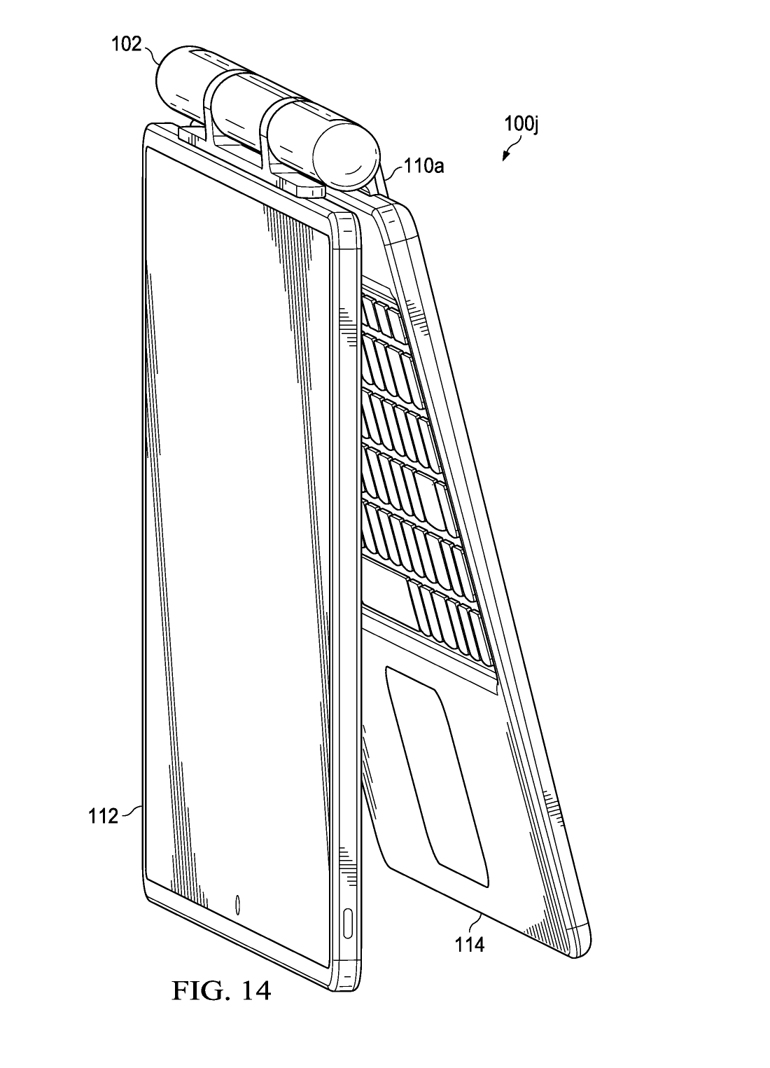

Turning to FIG. 14, FIG. 14 is a simplified orthographic view illustrating an embodiment of docking station 100j in accordance with one embodiment of the present disclosure. As illustrated in FIG. 14, first housing 112 and second housing 114 have been coupled to docking station 100j. For example, first housing 112 may have been coupled do docking station 100j using docking interconnect 106 and second housing 114 may have been coupled to docking station 100j using one or more secondary housing attachment means 150. In a specific example, one or more secondary housing attachment means 150 may be located on porch 110.

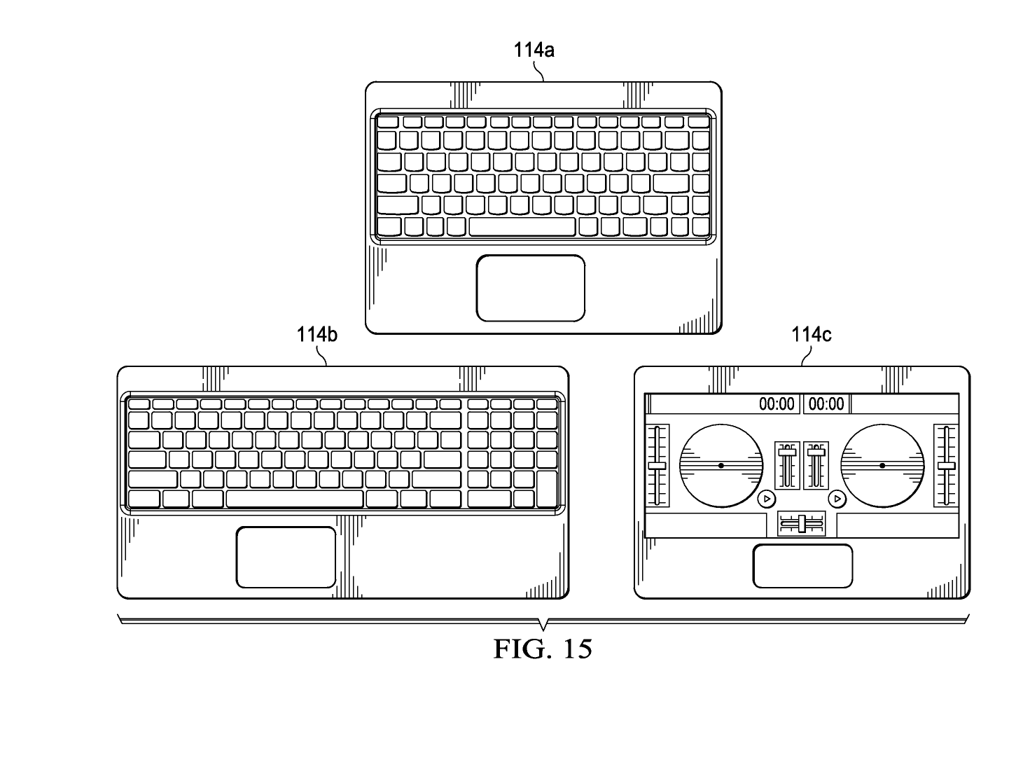

Turning to FIG. 15, FIG. 15 is a simplified orthographic view illustrating various embodiments of second housing 114 in accordance with one embodiment of the present disclosure. As illustrated in FIG. 14, second housing 114a could include a keyboard. The keyboard in second housing 114a could be a virtual keyboard or a physical keyboard. Second housing 114a could include a keyboard with a number pad. Second housing 114c could include a mixing keyboard. Each of second housing 114a-114c may be a virtual keyboard or a physical keyboard and are illustrated as only examples of various embodiments of second housing 114 as second housing 114 can include a variety of sizes and profiles and do not need to be the same size.

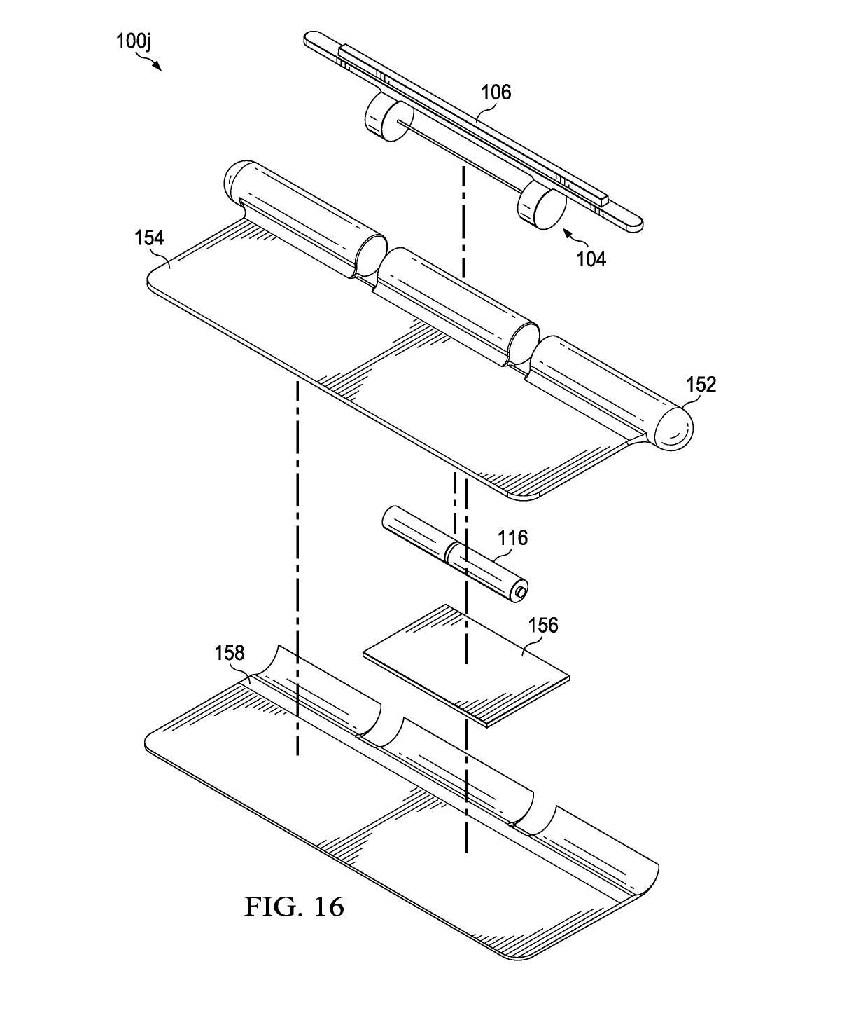

Turning to FIG. 16, FIG. 16 is a simplified exploded orthographic view illustrating an embodiment of docking station 100j in accordance with one embodiment of the present disclosure. Docking station 100j can include hinge 104, docking interconnect 106, charging element 116, a main body housing 152, a top cover 154, a wireless charging module 156, and a bottom cover 158. Wireless charging module 156 can include a power transmitting unit to wirelessly charge an electronic device.

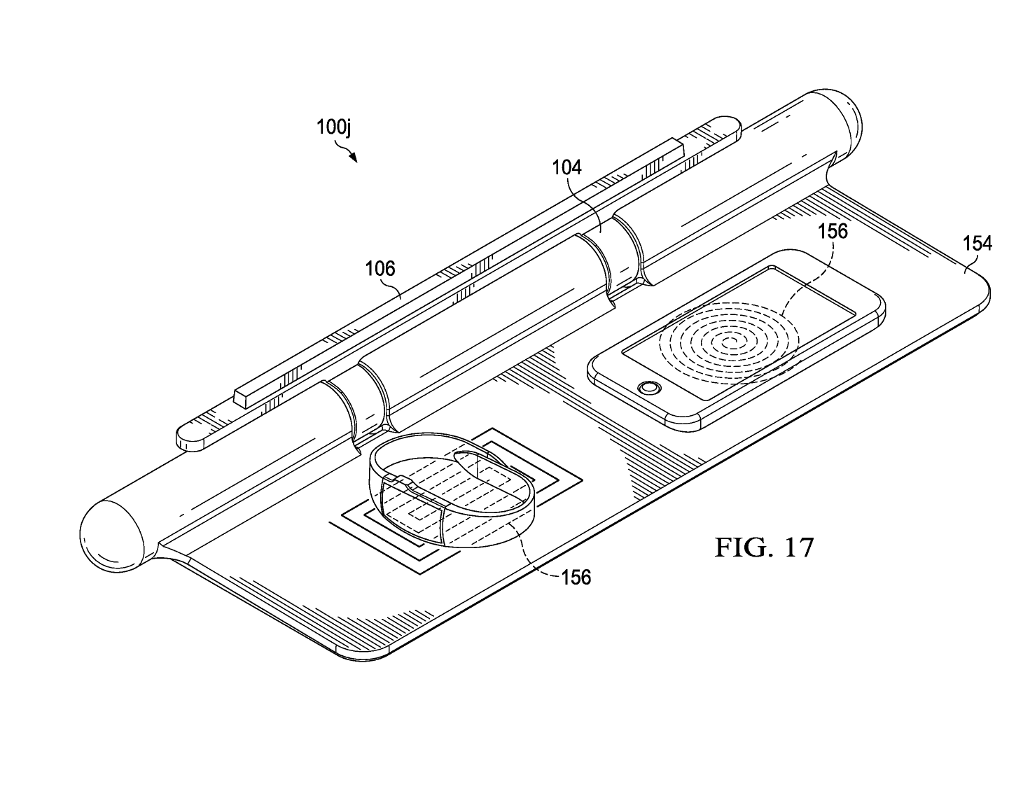

Turning to FIG. 17, FIG. 17 is a simplified exploded orthographic view illustrating an embodiment of docking station 100j in accordance with one embodiment of the present disclosure. Docking station 100j can include multiple wireless charging modules 156. In an example, each wireless charging module 156 can be designated for a specific device or type of wireless charging.

It is imperative to note that all of the specifications, dimensions, and relationships outlined herein (e.g., height, width, length, materials, etc.) have only been offered for purposes of example and teaching only. Each of these data may be varied considerably without departing from the spirit of the present disclosure, or the scope of the appended claims. The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the present disclosure has been illustrated with reference to particular elements and operations that facilitate the communication process, these elements and operations may be replaced by any suitable architecture, protocols, and/or processes that achieve the intended functionality of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example A1 is an electronic device that includes a main body, an interconnect attached to the main body, where the interconnect can electrically couple with different sized first housings, a hinge attached to the interconnect, where the hinge can rotatably couple the interconnect with the main body, and a porch, where the porch can accommodate different sized second housings.

In Example A2, the subject matter of Example A1 may optionally include where the main body includes a charging element and the charging element can recharge an onboard battery in one of the different sized first housings when the one of the different sized first housings is coupled to the interconnect.

In Example A3, the subject matter of any of the preceding ‘A’ Examples can optionally include where the main body includes a memory element and the memory element can be used by one of the different sized first housings when coupled to the interconnect.

In Example A4, the subject matter of any of the preceding ‘A’ Examples can optionally include where the main body includes a printing module and a paper port.

In Example A5, the subject matter of any of the preceding ‘A’ Examples can optionally include where the main body includes a scanning module and a paper port.

In Example A6, the subject matter of any of the preceding ‘A’ Examples can optionally include where the porch includes attachment means to connect one of the different sized second housings to the main body.

In Example A7, the subject matter of any of the preceding ‘A’ Examples can optionally include where the porch includes a second housing interconnect and the second housing interconnect can electrically couple the electronic device to one of the different sized second housings.

Example AA1 is a docking station that includes a main body, an interconnect attached to the main body, where the interconnect can electrically couple with different sized first housings, a hinge attached to the interconnect, where the hinge can rotatably couple the interconnect with the main body, and a porch, where the porch can accommodate different sized second housings.

In Example AA2, the subject matter of Example AA1 may optionally include where the main body includes a charging element and the charging element can recharge an onboard battery in one of the different sized first housings when the one of the different sized first housings is coupled to the interconnect.

In Example AA3, the subject matter of any of the preceding ‘AA’ Examples can optionally include where the main body includes a memory element and the memory element can be used by one of the different sized first housings when coupled to the interconnect.

In Example AA4, the subject matter of any of the preceding ‘AA’ Examples can optionally include where the main body includes a printing module, a scanning module, and a paper port.

In Example AA5, the subject matter of any of the preceding ‘AA’ Examples can optionally include where the porch includes attachment means to connect one of the different sized second housing to the porch.

Example M1 is a method that includes positioning first housing on a docking station. The docking station can include a main body, an interconnect attached to the main body, where the interconnect can electrically couple with different sized first housing, a hinge attached to the interconnect, and a porch, wherein the porch can accommodate different sized second housings.

In Example M2, the subject matter of any of the preceding ‘M’ Examples can optionally include where the main body includes a charging element and the charging element can recharge an onboard battery in one of the different sized first housings when the one of the different sized first housings is coupled to the interconnect.

In Example M3, the subject matter of any of the preceding ‘M’ Examples can optionally include where the main body includes a memory element and the memory element can be used by one of the different sized first housings when coupled to the interconnect.

In Example M4, the subject matter of any of the preceding ‘M’ Examples can optionally include where the main body includes a printing module, a scanning module, and a paper port.

An example system S1 can include an electronic device, where the electronic device includes a docking station. The docking station can include a main body, an interconnect attached to the main body, where the interconnect can electrically couple with different sized first housings, a hinge attached to the interconnect, and a porch, wherein the porch can accommodate different sized second housings.

An example system S2 can include where the main body includes a charging element and the charging element can recharge an onboard battery in one of the different sized first housings when the one of the different sized first housings is coupled to the interconnect.

In Example S3, the subject matter of any of the preceding ‘SS’ Examples can optionally include where the main body includes a memory element and the memory element can be used by one of the different sized first housings when coupled to the interconnect.

In Example S4, the subject matter of any of the preceding ‘SS’ Examples can optionally include where the main body includes a printing module, a scanning module, and a paper port.

1. An electronic device, comprising:
a main body;
an interconnect attached to the main body, wherein the interconnect can removably electrically couple with different sized first housings, wherein a viewing angle of the different sized first housings can be adjusted;
a hinge attached to the interconnect, wherein the hinge can rotatably couple the interconnect with the main body;
a wireless module; and
a porch, wherein the porch can accommodate different sized second housings.

2. The electronic device of claim 1, wherein the main body includes a charging element and the charging element can recharge an onboard battery in one of the different sized first housings when the one of the different sized first housings is coupled to the interconnect.

3. The electronic device of claim 1, wherein the main body includes a memory element and the memory element can be used by one of the different sized first housings when coupled to the interconnect.

4. The electronic device of claim 3, wherein the main body includes a printing module and a paper port.

5. The electronic device of claim 1, wherein the main body includes a scanning module and a paper port.

6. The electronic device of claim 4, wherein the porch includes attachment means to connect one of the different sized second housings to the main body.

7. The electronic device of claim 1, wherein the porch includes a second housing interconnect and the second housing interconnect can electrically couple the electronic device to one of the different sized second housings.

8. A docking station comprising:
a main body;
an interconnect attached to the main body, wherein the interconnect can electrically couple with different sized first housings, wherein a viewing angle of the different sized first housings can be adjusted;
a hinge attached to the interconnect, wherein the hinge can rotatably couple the interconnect with the main body;
a wireless module; and
a porch, wherein the porch can accommodate different sized second housings.

9. The docking station of claim 8, wherein the main body includes a charging element and the charging element can recharge an onboard battery in one of the different sized first housings when the one of the different sized first housings is coupled to the interconnect.

10. The docking station of claim 9, wherein the main body includes a memory element and the memory element can be used by one of the different sized first housings when coupled to the interconnect.

11. The docking station of claim 8, wherein the main body includes a printing module, a scanning module, and a paper port.

12. The docking station of claim 8, wherein the porch includes attachment means to connect one of the different sized second housing to the porch.

13. A method, comprising:
positioning a first housing on a docking station, wherein the docking station includes:
a main body;
an interconnect attached to the main body, wherein the interconnect can removably electrically couple with different sized first housing, wherein a viewing angle of the different sized first housings can be adjusted;
a hinge attached to the interconnect, wherein the hinge can rotatably couple the interconnect with the main body;
a wireless module; and
a porch, wherein the porch can accommodate different sized second housings.

14. The method of claim 13, wherein the main body includes a charging element and the charging element can recharge an onboard battery in one of the different sized first housings when the one of the different sized first housings is coupled to the interconnect.

15. The method of claim 13, wherein the main body includes a memory element and the memory element can be used by one of the different sized first housings when coupled to the interconnect.

16. The method of claim 15, wherein the main body includes a printing module, a scanning module, and a paper port.

17. A system, comprising:
an electronic device, wherein the electronic device includes a docking station, the docking station including:
a main body;
an interconnect attached to the main body, wherein the interconnect can removably electrically couple with different sized first housings, wherein a viewing angle of the different sized first housings can be adjusted;
a hinge attached to the interconnect, wherein the hinge can rotatably couple the interconnect with the main body;
a wireless module; and
a porch, wherein the porch can accommodate different sized second housings.

18. The system of claim 17, wherein the main body includes a charging element and the charging element can recharge an onboard battery in one of the different sized first housings when the one of the different sized first housings is coupled to the interconnect.

19. (canceled)

20. The system of claim 17, wherein the main body includes a printing module, a scanning module, and a paper port.

21. The electronic device of claim 1, wherein the porch can wirelessly charge an electronic device.
